(19) United States
(12) Patent Application Publication
(10) Pub. No.: US 2005/0058081 A1
(43) Pub. Date: Mar. 17, 2005

(54) Systems and methods for measuring the distance between devices

(76) Inventor: Brig Barnum Elliott, Arlington, MA (US)

Correspondence Address: Leonard C. Suchyta;c/o Christian Andersen, Verizon Corporate Services Group Inc., 600 Hidden Ridge, HQE03H01, Irving, TX, 75038, US

(21) Appl. No.: 10/663,870

(22) Filed: Sep. 16, 2003

(51) Int. Cl. H04L 12/26

(52) U.S. Cl. 370/252

(57) ABSTRACT

A network includes a first node (110) and a second node (120). The first node (110) generates a timestamp message (220) that includes a first value, transmits the timestamp message (220) to the second node (120), and records a second time value representing a time at which a portion of the timestamp message (220) is being transmitted. The second node (120) receives the timestamp message (220), generates a new timestamp message (440) in response to receiving the timestamp message (220), stores the first value from the timestamp message (220) in the new timestamp message (440), stores second node processing time information in the new timestamp message (440), and transmits the new timestamp message (440) to the first node (110). Upon receipt of the new timestamp message (440), the first node (110) records a third time value representing a time at which a portion of the new timestamp message (440) is received, and determines the distance between the first node (110) and the second node (120) using the first value, the second time value, the third time value, and the second node processing time information.

### FIELD OF THE INVENTION

The present invention relates generally to communications networks and, more particularly, to systems and methods for measuring the distance between devices in a communications network.

### BACKGROUND OF THE INVENTION

Certain kinds of systems require “range” information, often called “radio ranging” in radio frequency (RF) networks and “optical ranging” in optical networks, for network operations. That is, a given node in the network may need to know how far away another node is at some instant in time. If a number of such different nodes make distance measurements on each other, their relative locations can be determined with some accuracy by a kind of “surveying” approach.

Radio ranging is often performed using a kind of radar technique in which a radio pulse is bounced off the object for which a location determination is desired. It may also be performed by a well-known “time difference of arrival” (TDOA) technique. Cellular systems have recently begun using radio ranging in order to comply with emergency 911 (E-911) requirements in the United States. In addition, location determination techniques allow for the provision of location-based services, which are attractive to service providers. Radio ranging thus provides the basic information needed in order to do surveying and discover the location of a cell phone or wireless device.

Radio ranging also has military applicability. For example, the Enhanced Position Location and Reporting System (EPLRS) and Small Unit Operations (SUO) are two known radio ranging techniques that use a specialized time division multiple access (TDMA) approach to accessing the radio channel, with very precise time measurements to determine propagation time of an RF signal from a source device to a destination device.

However, these techniques rely on specialized forms of channel access and are not readily suitable for use with many forms of wireless networking technology, including the well-known IEEE 802.11 wireless local area networks (LANs), new forms of optical networking, and so forth. Thus, there is a need for new ways to determine the distance between devices.

### SUMMARY OF THE INVENTION

Systems and methods consistent with the principles of the invention provide a simplified and easily deployable technique for determining the distance between devices.

In accordance with the purpose of this invention as embodied and broadly described herein, a method for determining the distance between a first node and a second node in a network is provided. The method includes generating a timestamp message at the first node, where the timestamp message includes a first value; transmitting the timestamp message to the second node; and recording a second time value representing a time at which a portion of the timestamp message is being transmitted. The method further includes receiving the timestamp message at the second node; generating a new timestamp message at the second node in response to receiving the timestamp message; storing the first value from the timestamp message in the new timestamp message; storing second node processing time information in the new timestamp message; and transmitting the new timestamp message to the first node. The method also includes receiving the new timestamp message; recording a third time value representing a time at which a portion of the new timestamp message is received; and determining the distance between the first node and the second node using the first value, the second time value, the third time value, and the second node processing time information.

In another implementation consistent with the present invention, a method for determining the distance between a first node and a second node in a network is provided. The method, performed by the first node, includes generating a timestamp message that includes a first value, transmitting the timestamp message to the second node, recording a second time value representing a time at which the timestamp message is being transmitted, receiving a new timestamp message from the second node, where the new timestamp message includes the first value and a third time value representing the time during which the second node processed the timestamp message, recording a fourth time value representing a time at which the new timestamp message is received, and determining the distance between the first node and the second node using the second time value, the third time value, and the fourth time value.

In yet another implementation consistent with the present invention, a communications node includes a transmitter configured to transmit a message that includes a first value to another communications node and a receiver configured to receive a message from the other communications node. The received message includes the first value and a second time value representing a time period that the other communication node processed the message. The communications node further includes logic configured to record a third time value representing a time at which the message is transmitted by the transmitter, record a fourth time value representing a time at which the received message is received by the receiver, and determine the distance between the communications node and the another communications node based on the second time value, the third time value, and the fourth time value.

In still another implementation consistent with the present invention, a communications node includes a receiver configured to receive a message that includes a first value from another communications node and logic configured to generate a new message, store the first value in the new message, and store a second time value in the new message. The second time value represents a time period during which the communications node processes the message. The communications node further includes a transmitter configured to transmit the new message to the other communications node.

In a further implementation consistent with the present invention, a method for processing a message is provided. The method, performed by a communications node, includes receiving a message that includes a first value from another communications node; creating a new message in response to the receiving; storing the first value in the new message; storing a second time value in the new message, where the second time value represents a time period estimate based on a third time value representing a time at which at least one previous message was received and a fourth time value representing a time at which at least one previous new message was transmitted; and transmitting the new message to the other communications node.

In yet a further implementation consistent with the present invention, a method for determining the distance between a first node and a second node is provided. The method includes transmitting a Request to Send (RTS) frame from the first node to the second node; receiving the RTS frame at the second node; transmitting a Clear to Send (CTS) frame from the second node to the first node in response to receiving the RTS frame; transmitting a message to the second node in response to receiving the CTS frame, where the message includes a first value; and storing a second time value representing a time at which a portion of the message is being transmitted in a memory. The method further includes receiving the message at the second node; generating a new message at the second node in response to receiving the message; storing the first value from the message in the new message; storing second node processing time information in the new message; and transmitting the new message to the first node. The method also includes receiving the new message at the first node; recording a third time value representing a time at which a portion of the new message is received by the first node; and determining the distance between the first node and the second node using the second time value, the third time value, and the second node processing time information.

In still a further implementation consistent with the principles of the invention, a method for determining the distance between a first node and a second node is provided. The method includes transmitting a RTS frame from the first node to the second node, where the RTS frame includes a timestamp message that includes a first value; and storing, in a memory, a second time value representing a time at which the RTS frame is being transmitted. The method also includes receiving the RTS frame at the second node; storing the first value from the RTS frame in a CTS frame; storing second node processing time information in the CTS frame; and transmitting the CTS frame to the first node. The method further includes receiving the CTS frame at the first node; recording a third time value representing a time at which the CTS frame is received by the first node; and determining the distance between the first node and the second node using the second time value, the third time value, and the second node processing time information.

In another implementation consistent with the principles of the invention, a method for determining the distance between a first node and a second node is provided. The method includes transmitting a RTS frame from the first node to the second node, where the RTS frame includes a first timestamp message that includes a first value; and storing, in a memory, a second time value representing a time at which the RTS frame is being transmitted. The method also includes receiving the RTS frame at the second node; storing the first value from the RTS frame in a CTS frame; storing second node processing time information in the CTS frame; storing a second timestamp message that includes a third value in the CTS frame; transmitting the CTS frame to the first node; and recording a fourth time value representing a time at which the CTS frame is being transmitted. The method further includes receiving the CTS frame at the first node; recording a fifth time value representing a time at which the CTS frame is received by the first node; determining the distance between the first node and the second node using the second time value, the fifth time value, and the second node processing time information; storing the third value from the CTS frame in a data frame; storing first node processing time information in the data frame; and transmitting the data frame to the second node. The method includes receiving the data frame at the second node; recording a sixth time value representing a time at which the data frame is received by the second node; and determining the distance between the second node and the first node using the fourth time value, the sixth time value, and the first node processing time information.

In still another implementation consistent with the principles of the invention, a method for determining the distance between a first node and a second node is provided. The method includes transmitting a RTS frame from the first node to the second node; receiving the RTS frame at the second node; storing a first timestamp message in a CTS frame, where the first timestamp message includes a first value; transmitting the CTS frame to the first node; and storing, in a memory, a second time value representing a time at which the CTS frame is being transmitted. The method also includes receiving the CTS frame at the first node; storing the first value from the CTS frame in a data frame; storing first node processing time information in the data frame; storing a second timestamp message that includes a third value in the data frame; transmitting the data frame to the second node; and recording a fourth time value representing a time at which the data frame is being transmitted. The method further includes receiving the data frame at the second node; recording a fifth time value representing a time at which the data frame is received by the second node; determining the distance between the second node and the first node using the second time value, the fifth time value, and the first node processing time information; storing the third value from the data frame in an acknowledgement frame; storing second node processing time information in the acknowledgement frame; and transmitting the acknowledgement frame to the first node. The method also includes receiving the acknowledgement frame at the first node; recording a sixth time value representing a time at which the acknowledgement frame is received by the first node; and determining the distance between the first node and the second node using the fourth time value, the sixth time value, and the second node processing time information.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 illustrates an exemplary system in which systems and methods, consistent with the principles of the invention, may be implemented;

FIG. 2 illustrates an exemplary configuration of the transmitter logic of FIG. 1 in an implementation consistent with the principles of the invention;

FIG. 3 illustrates an exemplary configuration of a database consistent with the principles of the invention;

FIG. 4 illustrates an exemplary configuration of the receiver logic of FIG. 1 in an implementation consistent with the principles of the invention;

FIGS. 5-7 illustrate an exemplary process for determining the distance between nodes according to an implementation consistent with the principles of the invention;

FIG. 8 illustrates a conventional communication scheme between two nodes in a shared channel environment; and

FIG. 9 illustrates an exemplary communication scheme between two nodes in a shared channel environment for determining the distance between two nodes according to an implementation consistent with the principles of the invention.

### DETAILED DESCRIPTION

The following detailed description of implementations consistent with the present invention refers to the accompanying drawings. The same reference numbers in different drawings may identify the same or similar elements. Also, the following detailed description does not limit the invention. Instead, the scope of the invention is defined by the appended claims and equivalents.

Implementations consistent with the present invention determine the distance between nodes in a network. In one implementation, a first node generates a message that includes a local timestamp and transmits the message to a second node. The second node receives the message, stores a processing delay time (i.e., information indicating what delay was incurred by processing the message within the second node) in the message, and transmits the message back to the first node. Upon receipt of the message, the first node may determine the elapsed time between its current time and the time at which the first node sent this message to obtain the total round-trip time. By subtracting out the processing delay time, the first node may then determine the time it takes the message to go to the second node and back to the first node, which is typically twice the amount of time it takes to transmit a message from the first node to the second node. Accordingly, the first node can determine the distance to the second node.

### Exemplary System

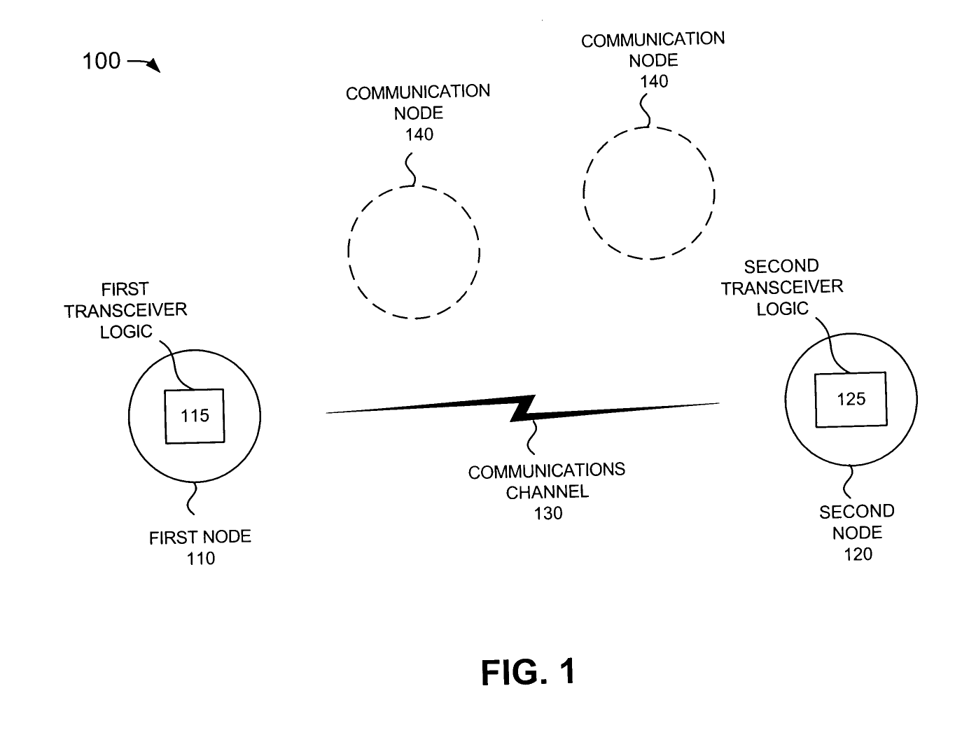

FIG. 1 illustrates an exemplary system 100 in which systems and methods, consistent with the principles of the invention, may be implemented. System 100 may include a first node 110, a second node 120, and one or more communication nodes 140 that communicate via a communications channel 130. The number of components illustrated in FIG. 1 has been shown for simplicity. It will be appreciated that a typical system may include more or fewer nodes and channels than illustrated in FIG. 1.

First node 110 may include one or more devices capable of communicating with other devices, such as second node 120, via communications channel 130. For example, first node 110 may include a computer system, such as a mainframe, minicomputer, personal computer, a laptop computer, a personal digital assistant (PDA), a cellular device, a wireless router or switch, an embedded real-time system, or other types of communication devices or software. In one implementation, first node 110 may include first transceiver logic 115 that allows first node 110 to transmit and receive data units (e.g., packets) to/from second node 120.

Second node 120 may include one or more devices capable of communicating with other devices, such as first node 110, via communications channel 130. For example, second node 120 may include a computer system, such as a mainframe, minicomputer, personal computer, a laptop computer, a PDA, a cellular device, a wireless router or switch, an embedded real-time system, or other types of communication devices or software. In one implementation, second node 120 may include second transceiver logic 125 that allows second node 120 to receive and transmit data units from/to first node 110. Communication nodes 140 may include other transmitting/receiving devices similar to those described above with respect to first node 110 and second node 120.

Communications channel 130 may include one or more wireless and/or optical links. In one implementation, communications channel 130 may include one or more dedicated links, such as a dedicated fiber or free-space optical link between first node 110 and second node 120, a dedicated radio or optical link between first node 110 and second node 120, a serial, frame relay, or SONET link between first node 110 and second node 120, etc. Alternatively, communications channel 130 may include one or more shared links (i.e., links in which other nodes, such communications nodes 140 share the links with first node 110 and second node 120), such as an 802.11 based radio network, a military tactical communications system based on radio frequency networks with omni-directional or directional antennas, an optical network, an underwater acoustic network, or the like.

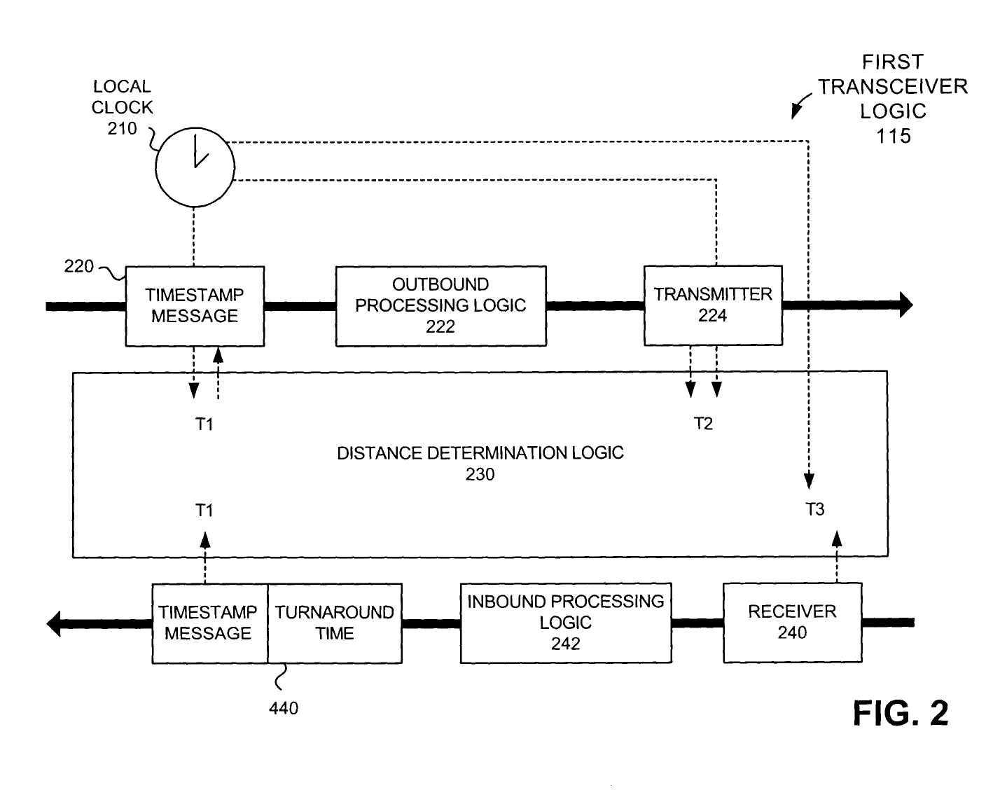

FIG. 2 illustrates an exemplary configuration of first transceiver logic 115 of FIG. 1 in an implementation consistent with the principles of the invention. It will be appreciated that the configuration illustrated in FIG. 2 is provided for explanatory purposes only and that many other configurations are possible.

As illustrated, first transceiver logic 115 may include a local clock 210, outbound processing logic 222, a transmitter 224, distance determination logic 230, a receiver 240, and inbound processing logic 242. Local clock 210 generates a highly accurate clock signal in a well-known manner for first transceiver logic 115. Local clock 210 need not be synchronized with other clocks within first node 110 or external to first node 110.

Outbound processing logic 222 may receive an outgoing message, such as timestamp message 220, and process the message for transmission over channel 130. In one implementation, outbound processing logic 222 may perform layer 2 and layer 1 processing of the message. The processing may include, for example, framing, addition of header and error correction information, conversion of bits to spread spectrum chips, modulation, and the like.

Transmitter 224 receives the message from outbound processing logic 222 and transmits the message over channel 130. Transmitter 224 may include any transmitter-like mechanism that enables first node 110 to transmit data over channel 130. For example, transmitter 224 may include devices for transmitting data over a wireless and/or optical link.

As will be described in greater detail below, distance determination logic 230 determines the distance between first node 110 and second node 120 based on the time, as determined by local clock 210, at which timestamp message 220 is transmitted from first node 110 and later received by first node 110. Distance determination logic 230 may include one or more processing devices and memory devices, such as a random access memory.

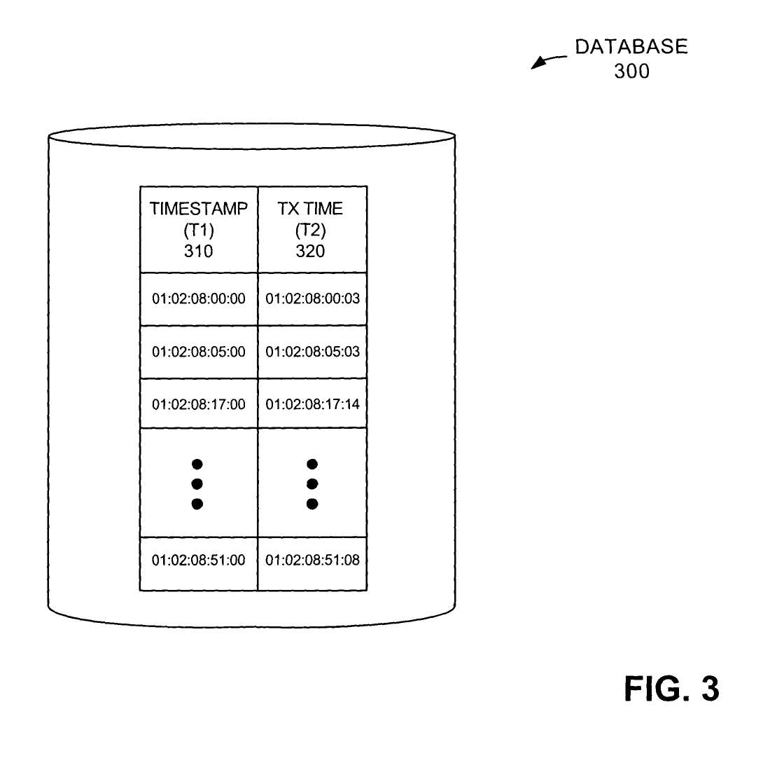

Distance determination logic 230 may be associated with a database for storing information used in determining the distance to nodes in system 100, such as second node 120. FIG. 3 illustrates an exemplary configuration of a database 300 that may be associated with distance determination logic 230 in an implementation consistent with the principles of the invention. Database 300 may be located within first node 110 or external to first node 110. As illustrated, database 300 may include a timestamp (T1) field 310 and a transmit (TX) time (T2) field 320.

Timestamp T1 field 310 may store timestamp values, obtained from reading local clock 210, that first node 110 stores in timestamp messages 220. Transmit time T2 field 320 may store time values representing the local time at which the last bit of the timestamp message in field 310 is being transmitted from first node 110. The values in timestamp T1 field 310 and transmit time T2 field 320 may be stored in an hour:minute:second:millisecond:microsecond format. In other implementations, the values in timestamp T1 field 310 and transmit time T2 field 320 may be stored in an hour:minute:second:millisecond:microsecond:nanosecond format. Other formats for storing time values may alternatively be used. Alternatively, the T1 field may be any bit sequence that may act as a database index, such as a sequence number. It will be appreciated that database 300 may include other fields than those illustrated in FIG. 3. For example, database 300 may also store a time value representing the time at which the last bit of a message is received by first node 110.

Returning to FIG. 2, receiver 240 may include any receiver-like mechanism that enables first node 110 to receive data over channel 130. For example, receiver 240 may include devices for receiving data from a wireless and/or optical link. Inbound processing logic 242 processes data received from channel 130. In one implementation, inbound processing logic 242 may perform layer 2 and layer 1 processing on data received from channel 130. The processing may include, for example, demodulation, error checking, and the like.

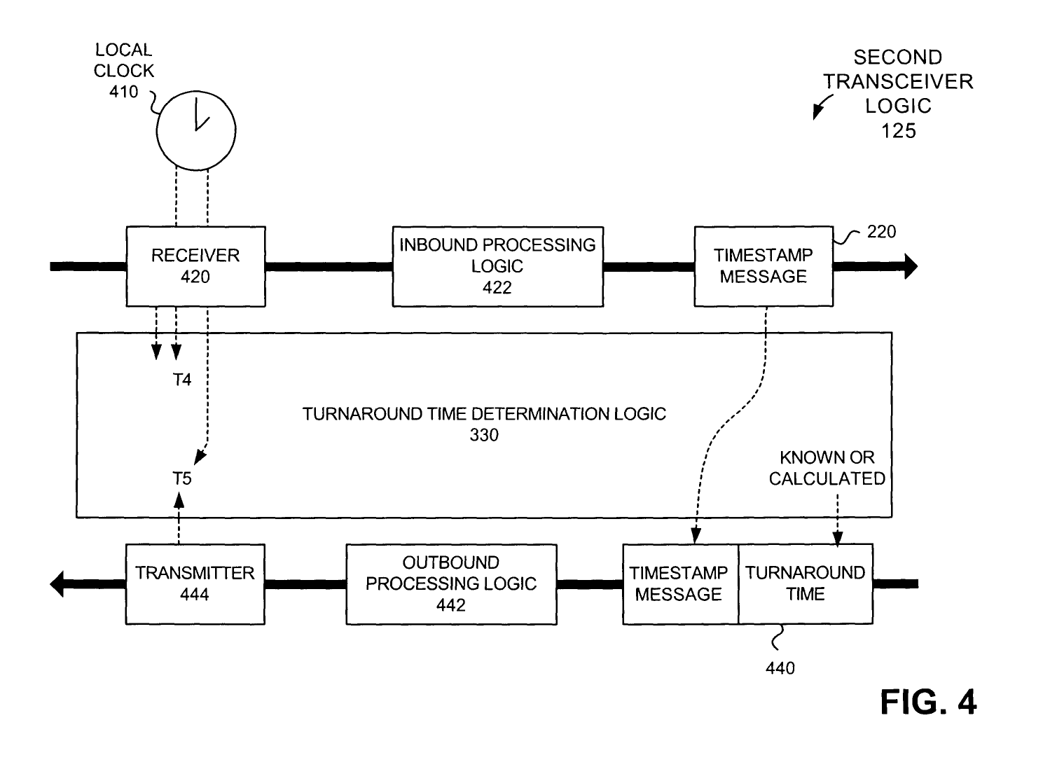

FIG. 4 illustrates an exemplary configuration of second transceiver logic 125 of FIG. 1 in an implementation consistent with the principles of the invention. It will be appreciated that the configuration illustrated in FIG. 4 is provided for explanatory purposes only and that many other configurations are possible.

As illustrated, second transceiver logic 125 may include a local clock 410, a receiver 420, inbound processing logic 422, turnaround time determination logic 430, outbound processing logic 442, and a transmitter 444. Local clock 410 generates a highly accurate clock signal in a well-known manner for second transceiver logic 125. Local clock 410 need not be synchronized with other clocks within second node 120 or external to second node 120.

Receiver 420 may include any receiver-like mechanism that enables second node 120 to receive data from channel 130. For example, receiver 420 may include devices for receiving data from wireless and/or optical links. Inbound processing logic 422 processes data received from channel 130. In one implementation, inbound processing logic 422 may perform layer 2 and layer 1 processing on data received from channel 130 to retrieve the original data transmitted by first node 110 (or another device). The processing may include, for example, demodulation, error checking, and the like. In one implementation, inbound processing logic 422 retrieves timestamp message 220 transmitted by first node 110.

Turnaround time determination logic 430 determines the time, as determined by local clock 410, that it takes second node 120 to process timestamp message 220 (referred to hereinafter as the “turnaround time”). Put another way, the turnaround time indicates how long the message spent within second node 120 from the time at which the last portion of the message (e.g., the last bit) was received at second node 120 up to the time at which the last bit of the message is transmitted back to first node 110. Turnaround time determination logic 430 may create, in response to receiving timestamp message 220, a new timestamp message 440 and may store the timestamp from timestamp message 220 and the turnaround time information in new timestamp message 440. Turnaround time determination logic 430 may include one or more processing devices and memory devices, such as a random access memory.

Outbound processing logic 442 may process a message, such as message 440, for transmission over channel 130. In one implementation, outbound processing logic 442 may perform layer 2 and layer 1 processing on messages transmitted by second node 120. The processing may include, for example, framing, addition of header and error correction information, modulation, and the like.

Transmitter 444 receives the messages from outbound processing logic 442 and transmits the messages over channel 130. Transmitter 444 may include any transmitter-like mechanism that enables second node 120 to transmit data over channel 130. For example, transmitter 444 may include devices for transmitting data over a wireless and/or optical link.

While first node 110 has been described as including first transceiver logic 115 and second node 120 has been described as including second transceiver logic 125, in other implementations consistent with the principles of the invention, first node 110 and second node 120 may both include first transceiver logic 115 and second transceiver logic 125. In those situations, the first transceiver logic and second transceiver logic within a particular node may share a local clock.

### Exemplary Processing

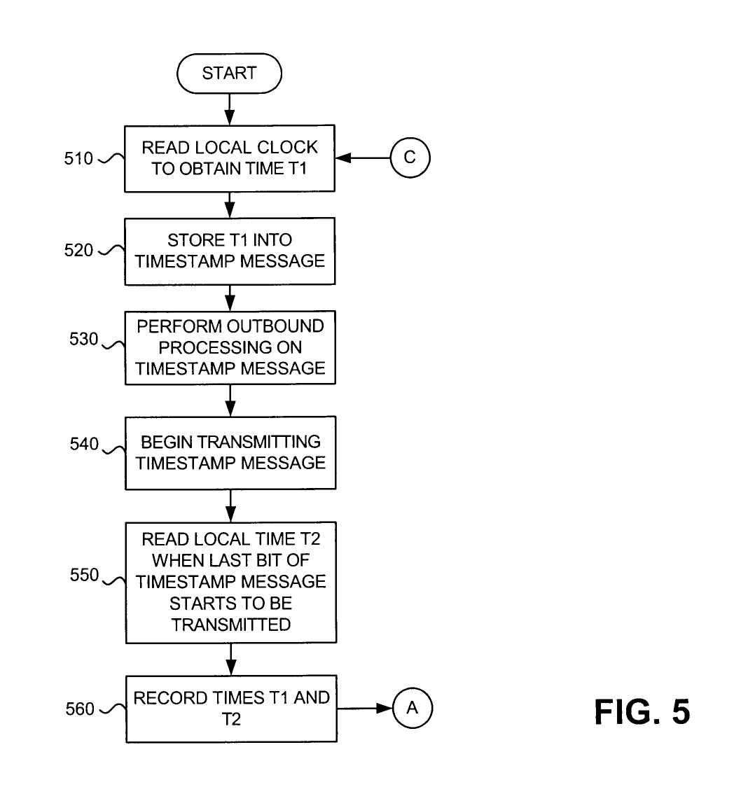

FIGS. 5-7 illustrate an exemplary process for determining the distance between nodes, such as first node 110 and second node 120, in an implementation consistent with the principles of the invention. Processing may begin with first node 110 determining that it needs to discover the distance to another node, such as second node 120, with which first node 110 is communicating. First node 110 may make this distance determination periodically, on demand, frequently, seldom, at variable intervals, or at other times. When first node 110 wants to determine the distance to second node 120, first node may read local clock 210 to obtain time T1 and store time T1 into a timestamp message, such as timestamp message 220 (acts 510 and 520, FIG. 5).

First node 110 may then perform outbound processing on timestamp message 220 (act 530). This timestamp message may be sent as a single, stand-alone frame or as a portion of a larger data unit. As described above, the outbound processing may include, for example, framing, addition of header and error correction information, modulation, and the like. Transmitter 224 may then begin transmitting timestamp message 220 (act 540). At the moment that a pre-designated portion of timestamp message 220 (e.g., the last bit, the first bit, or some other portion of timestamp message 220) starts to be transmitted, distance determination logic 230 may read the local time T2 from local clock 210 (act 550). It will be assumed hereafter that the pre-designated portion is the last bit of timestamp message 220. Distance determination logic 230 may record the time values T1 and T2 in a database, such as database 300 (act 560).

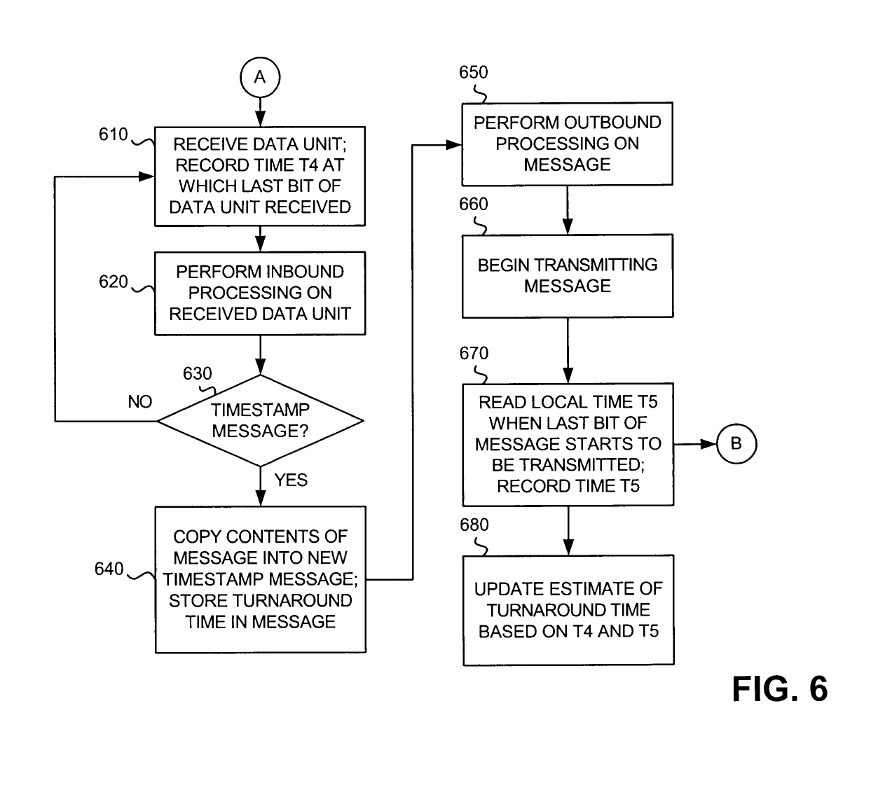

Second node 120 may receive a data unit, such as a data frame or packet, from channel 130 (act 610, FIG. 6). When the pre-designated portion of the data unit (i.e., the last bit) is being received, turnaround time determination logic 430 may read local clock 410 to obtain the time T4 at which the last bit of the data unit is received (act 610). Turnaround time determination logic 430 may store time T4 in a memory (e.g., a memory within turnaround time determination logic 430) (act 610). The data unit may then be processed (act 620). Inbound processing logic 422 may perform, for example, demodulation and/or error checking on the data unit. Inbound processing logic 422 may then inspect the data unit to determine if the data unit contains a timestamp message (act 630). If the data unit does not contain a timestamp message, the data unit may be processed in a conventional manner and processing may return to act 610. If the data unit contains a timestamp message 220, turnaround time determination logic 430 may copy the contents of timestamp message 220 into a new timestamp message 440 (act 640). Turnaround time determination logic 430 may also store turnaround time information into new timestamp message 440 (act 640).

As described above, the turnaround time information represents the amount of time that the timestamp message spent within second node 120. For some communication devices, the turnaround time information may be a fixed number in those devices where the processing of messages is deterministic. In other communication devices, the turnaround time must be estimated.

Second node 120 may then perform outbound processing on new timestamp message 440 (act 650). This timestamp message may be sent as a stand-alone frame or as a portion of a larger data unit. As described above, the outbound processing may include, for example, framing, addition of header and error correction information, modulation, and the like. Transmitter 434 may then begin transmitting new timestamp message 440 (act 660). At the moment that the last bit of new timestamp message 440 starts to be transmitted, turnaround time determination logic 430 may read the local time T5 from local clock 410 (act 670). Turnaround time determination logic 430 may record the time value T5 in the memory (act 670).

If desired, turnaround time determination logic 430 may update an estimate of the turnaround time by determining the turnaround time for this just-transmitted message 440 (act 680). Turnaround time determination logic 430 may determine the turnaround time by subtracting time T4 (i.e., the time at which the last bit of timestamp message 220 was received by second node 120) from time T5 (i.e., the time at which the last bit of new timestamp message 440 was transmitted by second node 120). Turnaround time determination logic 430 may make a series of these measurements to estimate (or refine the estimate of) the turnaround time. In one implementation, new timestamp message 440 may include not just an estimate of the turnaround time itself, but variances, etc., so that first node 110 can determine how good an estimate the turnaround time is, and thus, determine how good its estimate of the distance between first node 110 and second node 120 is.

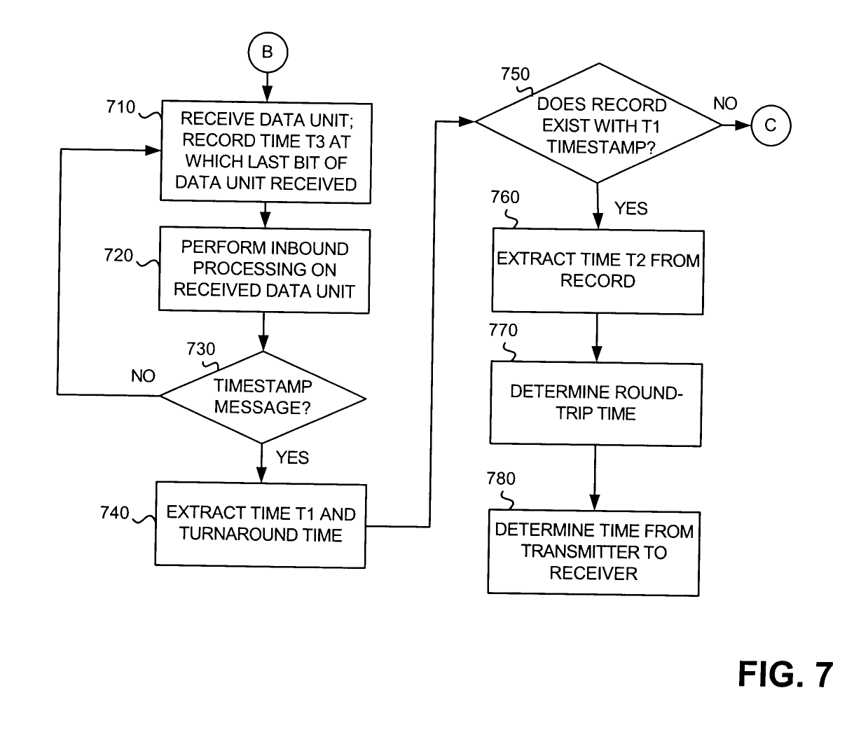

Processing may now return to first node 110. First node 110 may receive a data unit, such as a data frame or packet, from channel 130 (act 710, FIG. 7). When the last bit of the data unit is being received, distance determination logic 230 may read local clock 210 to obtain the time T3 at which the last bit of the data unit is received (act 710). Distance determination logic 230 may store time T3 (act 710). First node 110 may process the data unit (act 720). For example, inbound processing logic 242 may perform demodulation and/or error checking on the data unit. Inbound processing logic 242 may then inspect the data unit to determine if the data unit contains a timestamp message (act 730). If the data unit does not contain a timestamp message, the data unit may be processed in a conventional manner and processing may return to act 710. If the data unit contains a timestamp message 440, distance determination logic 230 may extract timestamp T1 and the turnaround time information from timestamp message 440 (act 740). Distance determination logic 230 may then determine whether a record exists for the timestamp T1 (act 750). Distance determination logic 230 may, for example, search timestamp field 310 of database 300 for the timestamp T1. If no record exists for timestamp T1, processing may return to act 510 (FIG. 5) with a new timestamp message being generated. If a record exists for timestamp T1, distance determination logic 230 may extract the time T2 from the record (act 760).

Distance determination logic 230 may determine the round-trip time (act 770) from the following equation:
Round-Trip Time=T3−T2−Turnaround Time.
In most instances, the round-trip time is twice the time that it takes a message to get from first node 110 to second node 120. Distance determination logic 230 may then determine the distance from first node 110 to second node 120 (act 780) from the following:

$$Distance ∝ = \frac{Round \text{-} Trip Time}{2} .$$

As an example, assume that the timestamp value T1 is 01:02:08:00:00 and the time value T2 at which the last bit of the timestamp message that includes the timestamp value T1 is transmitted is 01:02:08:00:03. Assume further that first node 110 receives a new timestamp message that includes the timestamp value T1 and a turnaround time of 00:00:00:03:00 from second node 120 at a time T3 of 01:02:08:05:03. In this situation, first node 110 may determine the round-trip time as 2 milliseconds. First node 110 may then determine the time to second node 120 to be 1 millisecond. For applications employing electromagnetic propagation in free-space, this corresponds to roughly 186 miles since electromagnetic radiation propagates at approximately 186,000 miles per second in free space. The transmission frequency need not be in the visible range.

In some communication systems, queues may exist along the transmit path. That is, second node 120 may not be able to reply to a timestamp message immediately, as there may already be data frames in the transmit queue of second node 120, which are scheduled to be sent before the timestamp reply can be sent. This will make the turnaround time highly variable. To remedy this situation, first node 110 may transmit an “alert” message to second node 120 shortly before first node 110 sends the actual timestamp message. Upon receipt of the alert message, second node 120 may transmit all messages that remain in its transmit queue and refrain from enqueuing any further messages. Put another way, second node 120 may drain its transmit queue. Then, upon receipt of the actual timestamp message, second node 120 may perform the processing described above with respect to FIG. 6. The time interval between the alert and timestamp messages may be chosen to be the maximal possible time needed to drain the transmit queue (if it is desired that every distance measurement succeed). Alternatively, the time interval can be chosen to be an amount that is statistically likely for the transmit queue to drain. Then, if the transmit queue is not in fact drained, second node 120 may simply fail to respond to the timestamp message. When no reply is received, first node 110 may resend the timestamp message.

While the above-processing focused on the use of a timestamp message for determining the distance between two nodes, implementations consistent with the principles of the invention are not so limited. In other implementations, a fixed set of locations in the header of some or all data frames (or packets) may be set aside for timestamp and turnaround time fields. As another alternative, the necessary information may be “piggybacked” into other messages that are already scheduled to be transmitted, such as control traffic messages, data messages, etc. In such an implementation, first node 110 and second node 120 would need to accurately track when the messages are transmitted, received, and the turnaround time (i.e., the amount of time that a message spent within second node 120 from the time at which the last portion of the message (e.g., the last bit) was received at second node 120 up to the time at which the last bit of the message is transmitted back to first node 110). Time/distance measurements could then be made on a more or less continuous basis between all sets of communicating nodes. This information can be used for ongoing, accurate surveying of the exact locations of nodes relative to each other, which is a very valuable high-level function in many applications.

Implementations consistent with the principles of the invention may also be implemented in a shared channel environment, such as a radio frequency medium governed by Carrier Sense Multiple Access/Collision Avoidance (CSMA/CA) channel contention. In this situation, other nodes, such as communication nodes 140, may share communications channel 130 with first node 110 and second node 120.

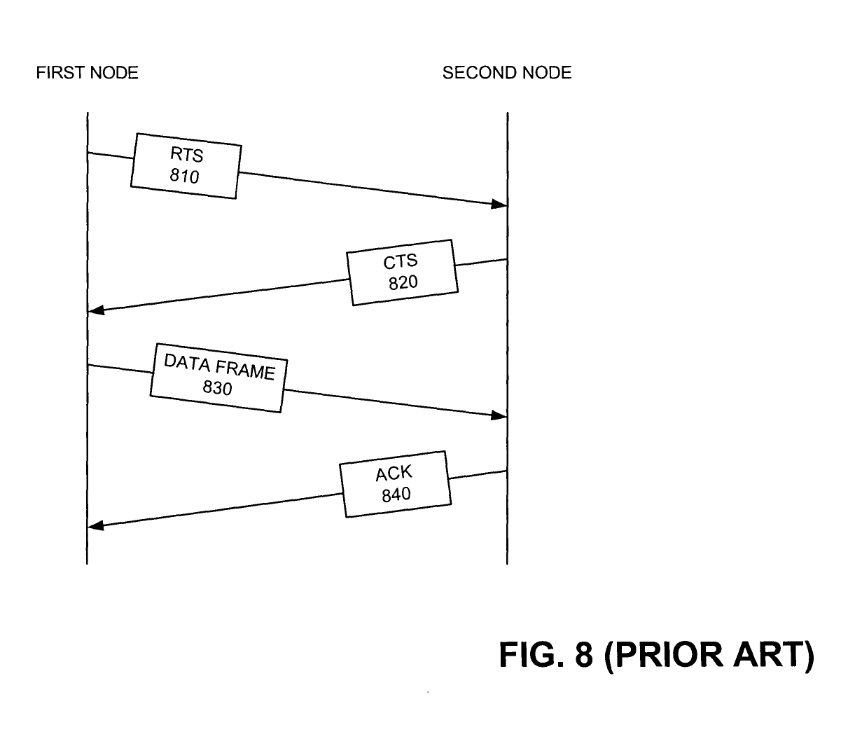

FIG. 8 illustrates a conventional communication scheme between two nodes in a shared channel (e.g., CSMA) environment. To gain access to the shared channel, the first node transmits a Request to Send (RTS) frame 810 that includes, among other things, a node identifier for the intended receiver (i.e., the second node). If the second node determines that other nodes are already using the channel in its vicinity (or if the second node fails to receive RTS frame 810), the second node simply remains silent. In such an event, the first node retransmits RTS frame 810 after some predetermined period of time.

Eventually, the channel will be free and the second node will receive RTS frame 810. In response, the second node sends a Clear to Send (CTS) frame 820 to the first node, which acts to seize the channel so that other nodes are prevented from using the channel for the duration of the transaction. Upon receipt of CTS frame 820, the first node may transmit a data frame 830 to the second node. The second node replies to the data frame by transmitting a short Acknowledgement (ACK) message 840. Other nodes may then use the channel.

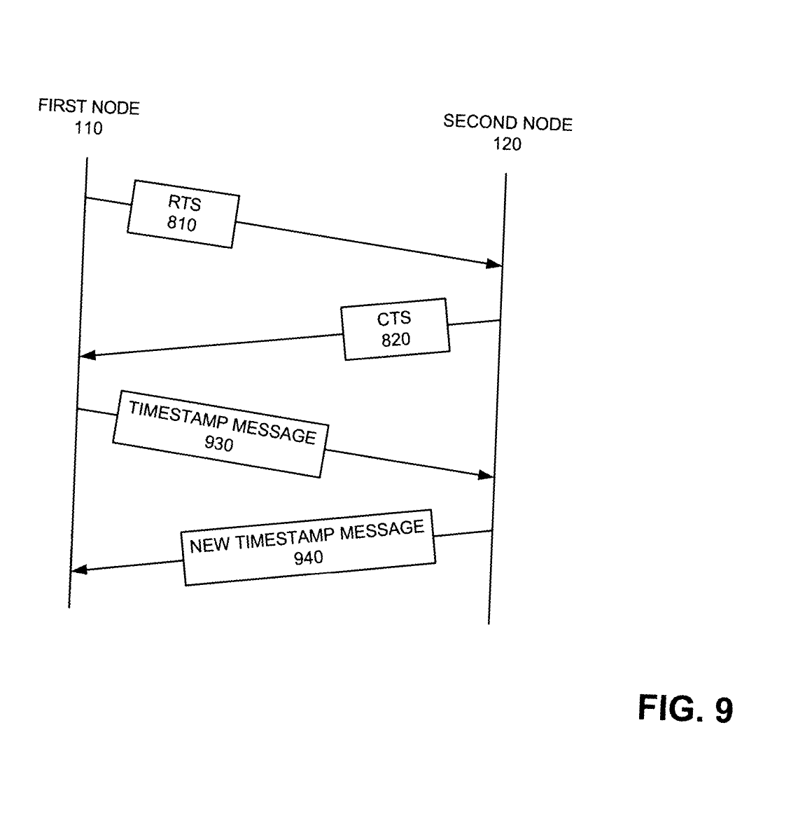

FIG. 9 illustrates an exemplary communication scheme between two nodes in a shared channel (e.g., CSMA) environment for determining the distance between the two nodes in an implementation consistent with the principles of the invention. To gain access to the shared channel, a first node, such as first node 110, may transmit a Request to Send (RTS) frame 810 that includes, among other things, a node identifier for the intended receiver (i.e., second node 120). If second node 120 determines that other nodes are already using the channel in its vicinity (or if second node 120 fails to receive RTS frame 810), second node 120 may not respond to RTS frame 810 (i.e., second node 120 may simply remain silent). In such an event, first node 110 may retransmit RTS frame 810 after some predetermined period of time.

Eventually, the channel will be free and second node 120 will receive RTS frame 810. In response, second node 120 may send a Clear to Send (CTS) frame 820 to first node 110, which acts to seize the channel so that other nodes are prevented from using the channel for the duration of the transaction. Upon receipt of CTS frame 820, first node 110 may transmit a timestamp message 930 to second node 120 in the manner described above with respect to FIG. 5. Second node 120 may store the contents of timestamp message 930 into a new timestamp message 940, along with turnaround time information, and transmit new timestamp message 940 back to first device 110 in the manner described above with respect to FIG. 6. Upon receipt of new timestamp message 940, first node 110 may determine the distance between first node 110 and second node 120 in the manner described above with respect to FIG. 7. In this implementation, new timestamp message 940 may act like Acknowledgement message 840 (FIG. 8) so as to release the channel for use by other nodes. In this interaction, each node has the chance to measure its roundtrip time to the other node, and thus each node may determine the distance between nodes in the course of a single packet transmission from one to the other.

In alternative implementations, timestamp message 930 and new timestamp message 940 may be transmitted in one or more of RTS frame 810, CTS frame 820, data frame 830, and Acknowledgement message 840. For example, first node 110 may transmit the timestamp message in a RTS frame. In response, second node 120 may transmit the new timestamp message in a CTS frame. First node 110 may then make the distance determination upon receipt of the CTS frame.

### CONCLUSION

Systems and methods, consistent with the principles of the invention, determine the distance between nodes in a network. In one implementation, a first node generates a message that includes a local timestamp and transmits the message to a second node. The second node receives the message, stores a processing delay time (i.e., information indicating the delay that was incurred by processing the message within the second node) in the message, and transmits the message back to the first node. Upon receipt of the message, the first node may determine the elapsed time between its current time and the time at which the first node sent this message to obtain the total round-trip time. By subtracting out the processing delay time, the first node may then determine the time it takes the message to go to the second node and back to the first node, which is typically twice the amount of time it takes to get from the first node to the second node. Accordingly, the first node can determine the distance to the second node.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, certain portions of the invention have been described as “logic” that performs one or more functions. This logic may include hardware, such as an application specific integrated circuit or a field programmable gate array, software, or a combination of hardware and software.

While series of acts have been described with regard to FIGS. 5-7, the order of the acts may be varied in other implementations consistent with the present invention. Moreover, non-dependent acts may be implemented in parallel.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

1. A method for determining distance between a first node and a second node in a network, comprising:
generating a timestamp message at the first node, the timestamp message including a first value;
transmitting the timestamp message to the second node;
recording a second time value representing a time at which a portion of the timestamp message is being transmitted;
receiving the timestamp message at the second node;
generating a new timestamp message at the second node in response to receiving the timestamp message;
storing the first value from the timestamp message in the new timestamp message;
storing second node processing time information in the new timestamp message;
transmitting the new timestamp message to the first node;
receiving the new timestamp message;
recording a third time value representing a time at which a portion of the new timestamp message is received; and
determining the distance between the first node and the second node using the first value, the second time value, the third time value, and the second node processing time information.

2. The method of claim 1 wherein the transmitting the timestamp message to the second node and the transmitting the new timestamp message to the first node include:
transmitting the timestamp message and the new timestamp message over a free-space link.

3. The method of claim 2 wherein the free-space link includes a radio link.

4. The method of claim 2 wherein the free-space link includes an optical link.

5. The method of claim 1 wherein the transmitting the timestamp message to the second node and the transmitting the new timestamp message to the first node include:
transmitting the timestamp message and the new timestamp message over a fiber optic link.

6. A method for determining distance between a first node and a second node in a network, the method, performed by the first node, comprising:
generating a timestamp message, the timestamp message comprising a first value;
transmitting the timestamp message to the second node;
recording a second time value representing a time at which the timestamp message is being transmitted;
receiving a new timestamp message from the second node, the new timestamp message comprising the first value and a third time value representing the time during which the second node processed the timestamp message;
recording a fourth time value representing a time at which the new timestamp message is received; and
determining the distance between the first node and the second node using the second time value, the third time value, and the fourth time value.

7. The method of claim 6 wherein the first node communicates with the second node over a free-space link.

8. The method of claim 7 wherein the free-space link includes a radio link.

9. The method of claim 7 wherein the free-space link includes an optical link.

10. The method of claim 6 wherein the first node communicates with the second node over a fiber optic link.

11. The method of claim 6 further comprising:
obtaining the first value and the second time value by reading a local clock.

12. The method of claim 6 wherein the determining includes:
determining a round-trip time by subtracting the second time value and the third time value from the fourth time value, and
determining the distance between the first node and the second node by dividing the round-trip time by two.

13. The method of claim 6 further comprising:
transmitting, prior to transmitting the timestamp message, a first message to the second node, the first message instructing the second node to stop enqueing messages for transmission and transmit messages already enqueued,
wherein the transmitting the timestamp message occurs a predetermined time period after transmitting the first message.

14. The method of claim 13 wherein the predetermined time period is a maximum period needed for the second node to transmit enqueued messages.

15. The method of claim 13 wherein the predetermined time period is an amount of time in which the second node is statistically likely to transmit enqueued messages.

16. In a first node, a system for determining distance between the first node and a second node, comprising:
means for generating a message, the message comprising a first value;
means for transmitting the message to the second node;
means for storing a second time value representing a time at which the message is being transmitted;
means for receiving a message from the second node, the received message comprising the first value and a third time value representing a time period during which the second node processed the message;
means for recording a fourth time value representing a time at which the received message is received; and
means for determining the distance between the first node and the second node using the first value, the second time value, the third time value, and the fourth time value.

17. A communications node comprising:
a transmitter configured to transmit a message to another communications node, the message comprising a first value;
a receiver configured to receive a message from the other communications node, the received message comprising the first value and a second time value representing a time period that the other communication node processed the message; and
logic configured to:
record a third time value representing a time at which the message is transmitted by the transmitter,
record a fourth time value representing a time at which the received message is received by the receiver, and
determine distance between the communications node and the other communications node based on the second time value, the third time value, and the fourth time value.

18. The communications node of claim 17 wherein, when transmitting the message, the transmitter is configured to:
transmit the message via a packetized communications link.

19. The communications node of claim 17 wherein, when transmitting the message, the transmitter is configured to:
transmit the message via a free-space link.

20. The communications node of claim 19 wherein the free-space link includes a radio link.

21. The communications node of claim 19 wherein the free-space link includes an optical link.

22. The communications node of claim 17 wherein, when transmitting the message, the transmitter is configured to:
transmit the message via a Carrier Sense Multiple Access (CSMA) based communications link.

23. The communications node of claim 17 wherein the first time value is stored in a header of the message.

24. The communications node of claim 17 wherein the first time value is piggybacked into a message that is scheduled to be transmitted to the other communications node.

25. The communications node of claim 17 wherein, when determining the distance between the communications node and the other communications node, the logic is configured to:
determine a round-trip time by subtracting the second time value and the third time value from the fourth time value, and
determine the distance between the communications node and the other communications node by dividing the round-trip time by two.

26. A communications node comprising:
a receiver configured to receive a message from another communications node, the message comprising a first value;
logic configured to:
generate a new message,
store the first value in the new message, and
store a second time value in the new message, the second time value representing a time period during which the communications node processes a message; and
a transmitter configured to transmit the new message to the other communications node.

27. The communications node of claim 26 wherein the time period is an estimate based on a third time value that represents a time at which a last bit of a previous message was received by the receiver and a fourth time value representing a time at which a last bit of a previous new message was transmitted by the transmitter.

28. The communications node of claim 27 wherein the logic is further configured to:
update the time period estimate.

29. The communications node of claim 28 wherein, when updating the time period estimate, the logic is configured to:
record a fifth time value that represents a time at which a last bit of the message is received by the receiver and a sixth time value representing a time at which a last bit of the new message is transmitted by the transmitter,
determine a turnaround time by subtracting the fifth time value from the sixth time value, and
update the time period estimate based on the turnaround time.

30. The communications node of claim 26 wherein the logic is further configured to:
store information regarding a variance of the second time value in the new message.

31. A method, performed by a communications node, for processing a message, the method comprising:
receiving a message from another communications node, the message including a first value;
creating a new message in response to the receiving;
storing the first value in the new message;
storing a second time value in the new message, the second time value representing a time period estimate based on a third time value representing a time at which at least one previous message was received and a fourth time value representing a time at which at least one previous new message was transmitted; and
transmitting the new message to the other communications node.

32. The method of claim 31 further comprising:
updating the time period estimate.

33. The method of claim 32 wherein the updating the time period estimate includes:
recording a fifth time value that represents a time at which a last bit of the message is received and a sixth time value representing a time at which a last bit of the new message is transmitted,
determining a turnaround time by subtracting the fifth time value from the sixth time value, and
updating the time period estimate based on the turnaround time.

34. The method of claim 31 further comprising:
storing information regarding a variance of the second time value in the new message.

35. A method for determining distance between a first node and a second node, the method comprising:
transmitting a Request to Send (RTS) frame from the first node to the second node;
receiving the RTS frame at the second node;
transmitting a Clear to Send (CTS) frame from the second node to the first node in response to receiving the RTS frame;
transmitting a message to the second node in response to receiving the CTS frame, the message including a first value;
storing, in a memory, a second time value representing a time at which a portion of the message is being transmitted;
receiving the message at the second node;
generating a new message at the second node in response to receiving the message;
storing the first value from the message in the new message;
storing second node processing time information in the new message;
transmitting the new message to the first node;
receiving the new message at the first node;
recording a third time value representing a time at which a portion of the new message is received by the first node; and
determining the distance between the first node and the second node using the second time value, the third time value, and the second node processing time information.

36. The method of claim 35 wherein the determining includes:
using the first value to retrieve the second time value from the memory.

37. A method for determining distance between a first node and a second node, the method comprising:
transmitting a Request to Send (RTS) frame from the first node to the second node, the RTS frame including a timestamp message that includes a first value;
storing, in a memory, a second time value representing a time at which the RTS frame is being transmitted;
receiving the RTS frame at the second node;
storing the first value from the RTS frame in a Clear to Send (CTS) frame;
storing second node processing time information in the CTS frame;
transmitting the CTS frame to the first node;
receiving the CTS frame at the first node;
recording a third time value representing a time at which the CTS frame is received by the first node; and
determining the distance between the first node and the second node using the second time value, the third time value, and the second node processing time information.

38. A method for determining distance between a first node and a second node, the method comprising:
transmitting a Request to Send (RTS) frame from the first node to the second node, the RTS frame including a first timestamp message that includes a first value;
storing, in a memory, a second time value representing a time at which the RTS frame is being transmitted;
receiving the RTS frame at the second node;
storing the first value from the RTS frame in a Clear to Send (CTS) frame;
storing second node processing time information in the CTS frame;
storing a second timestamp message that includes a third value in the CTS frame;
transmitting the CTS frame to the first node;
recording a fourth time value representing a time at which the CTS frame is being transmitted;
receiving the CTS frame at the first node;
recording a fifth time value representing a time at which the CTS frame is received by the first node;
determining the distance between the first node and the second node using the second time value, the fifth time value, and the second node processing time information;
storing the third value from the CTS frame in a data frame;
storing first node processing time information in the data frame;
transmitting the data frame to the second node;
receiving the data frame at the second node;
recording a sixth time value representing a time at which the data frame is received by the second node; and
determining the distance between the second node and the first node using the fourth time value, the sixth time value, and the first node processing time information.

39. A method for determining distance between a first node and a second node, the method comprising:
transmitting a Request to Send (RTS) frame from the first node to the second node;
receiving the RTS frame at the second node;
storing a first timestamp message in a Clear to Send (CTS) frame, the first timestamp message including a first value;
transmitting the CTS frame to the first node;
storing, in a memory, a second time value representing a time at which the CTS frame is being transmitted;
receiving the CTS frame at the first node;
storing the first value from the CTS frame in a data frame;
storing first node processing time information in the data frame;
storing a second timestamp message that includes a third value in the data frame;
transmitting the data frame to the second node;
recording a fourth time value representing a time at which the data frame is being transmitted;
receiving the data frame at the second node;
recording a fifth time value representing a time at which the data frame is received by the second node;
determining the distance between the second node and the first node using the second time value, the fifth time value, and the first node processing time information;
storing the third value from the data frame in an acknowledgement frame;
storing second node processing time information in the acknowledgement frame;
transmitting the acknowledgement frame to the first node;
receiving the acknowledgement frame at the first node;
recording a sixth time value representing a time at which the acknowledgement frame is received by the first node; and
determining the distance between the first node and the second node using the fourth time value, the sixth time value, and the second node processing time information.
